(19) United States
(12) Patent Application Publication
(10) Pub. No.: US 2021/0271954 A1
(43) Pub. Date: Sep. 2, 2021

(54) COUNTER FOR COUNTING EMPTY RECYCLABLE CONTAINERS

(71) Applicant: Robert Gagnon, Lantz (CA)

(72) Inventor: Robert Gagnon, Lantz (CA)

(21) Appl. No.: 17/184,355

(22) Filed: Feb. 24, 2021

(30) Foreign Application Priority Data
Feb. 27, 2020 (CA) CA3073885

(51) Int. Cl. G06M 1/08

(52) U.S. Cl. CPC G06M 1/083

(57) ABSTRACT

A counter for counting objects placed therethrough into a collecting device is provided. The counter comprises a holding structure having an opening disposed therein. The opening is adapted for enabling placement of the objects therethrough into the collecting device. A counting device is mounted to the holding structure in proximity to the opening such that the counting device advances a count of the objects by one when one of the objects is moved through the opening.

### FIELD OF THE INVENTION

The present invention relates to recycling of empty recyclable containers, and more particularly to a counter for counting empty recyclable containers.

### BACKGROUND OF THE INVENTION

In order to encourage recycling, it is becoming more and more commonplace that a cash deposit is imposed on beverage containers purchased by consumers. Typically, after a consumer consumes the beverage stored in the container, the consumer collects the empty recyclable container and returns the collected containers to a return centre, for example, at a supermarket or a designated redemption centre, for a return of the deposit. Typically, the recyclable containers are made in various sizes, for example, as small cans or large bottles, and are made of various materials, for example, glass, metal, or plastic.

Unfortunately, since commercially available container counting machines are large in size, complex, and expensive, the process of counting the containers at most return centres is performed manually, thus requiring a considerable amount of time for staff to spend for counting while customers are waiting. Furthermore, when manually counting larger numbers of containers there is an increased risk of counting errors.

It is desirable to provide a counter for counting empty recyclable containers that is simple and cost effective for residential and small business use.

It is also desirable to provide a counter for counting empty recyclable containers that is easy to use.

It is also desirable to provide a counter for counting empty recyclable containers that is easy to install and fits commercially available bins.

It is also desirable to provide a counter for counting empty recyclable containers that is capable of counting containers having different sizes.

### SUMMARY OF THE INVENTION

Accordingly, one object of the present invention is to provide a counter for counting empty recyclable containers that is simple and cost effective for residential and small business use.

Another object of the present invention is to provide a counter for counting empty recyclable containers that is easy to use.

Another object of the present invention is to provide a counter for counting empty recyclable containers that is easy to install and fits commercially available bins.

Another object of the present invention is to provide a counter for counting empty recyclable containers that is capable of counting containers having different sizes.

According to one aspect of the present invention, there is provided a counter for counting objects placed therethrough into a collecting device. The counter comprises a holding structure having an opening disposed therein. The opening is adapted for enabling placement of the objects therethrough into the collecting device. A counting device is mounted to the holding structure in proximity to the opening such that the counting device advances a count of the objects by one when one of the objects is moved through the opening.

According to the aspect of the present invention, there is provided a counter for counting objects placed therethrough into a collecting device. The counter comprises a holding structure having an opening disposed therein. The opening is adapted for enabling placement of the objects therethrough into the collecting device. A counting device is mounted to the holding structure in proximity to the opening such that the counting device advances a count of the objects by one when one of the objects is moved through the opening. The counting device is a mechanical counting device having a first end of a lever pivotally movable mounted thereto is adapted for advancing the count for each stroke of the lever.

According the aspect of the present invention, there is provided a counter for counting objects placed therethrough into a collecting device. The counter comprises a holding structure having an opening disposed therein. The opening is adapted for enabling placement of the objects therethrough into the collecting device. A counting device is mounted to the holding structure in proximity to the opening such that the counting device advances a count of the objects by one when one of the objects is moved through the opening. The counting device is a mechanical counting device having a first end of a lever pivotally movable mounted thereto is adapted for advancing the count for each stroke of the lever. A guiding structure extends from the holding structure into the opening such that the objects when moved through the opening are guided towards a second end of the lever.

The advantage of the present invention is that it provides a counter for counting empty recyclable containers that is simple and cost effective for residential and small business use.

A further advantage of the present invention is that it provides a counter for counting empty recyclable containers that is easy to use.

A further advantage of the present invention is that it provides a counter for counting empty recyclable containers that is easy to install and fits commercially available bins.

A further advantage of the present invention is that it provides a counter for counting empty recyclable containers that is capable of counting containers having different sizes.

### BRIEF DESCRIPTION OF THE DRAWINGS

A preferred embodiment of the present invention is described below with reference to the accompanying drawings, in which:

FIGS. 1a to 1d are simplified block diagrams illustrating in a top view, a perspective top view, a bottom view, and a perspective bottom view, respectively, a counter for counting empty recyclable containers according to a preferred embodiment of the invention;

FIGS. 1e and 1f are simplified block diagrams illustrating in perspective top views placement of two different sized objects through the counter for counting empty recyclable containers according to the preferred embodiment of the invention;

FIGS. 1g and 1h are simplified block diagrams illustrating in cross-sectional views placement of an object through the counter for counting empty recyclable containers according to the preferred embodiment of the invention;

FIGS. 2a and 2b are simplified block diagrams illustrating in a perspective top view and a cross-sectional view, respectively, a counter for counting empty recyclable containers according to another preferred embodiment of the invention; and,

FIGS. 3a to 3c are simplified block diagrams illustrating in a top view, a cross-sectional view, and a top view, respectively, a counter for counting empty recyclable containers according to yet another preferred embodiment of the invention.

### DESCRIPTION OF THE PREFERRED EMBODIMENT

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are now described.

While the description of the preferred embodiments hereinbelow is with reference to counting empty recyclable containers such as, for example, empty cans and bottles, it will become evident to those skilled in the art that the embodiments of the invention are not limited thereto, but are also adaptable for counting various other objects having different shapes in a residential or small business environment.

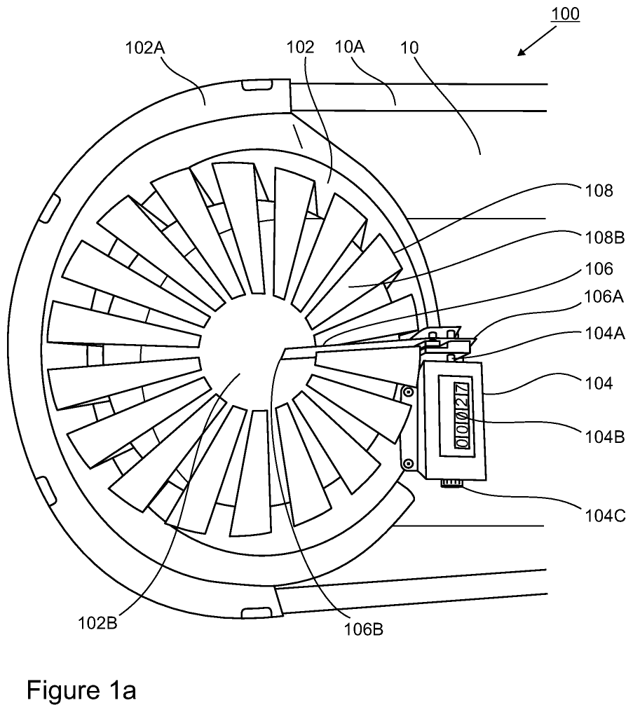

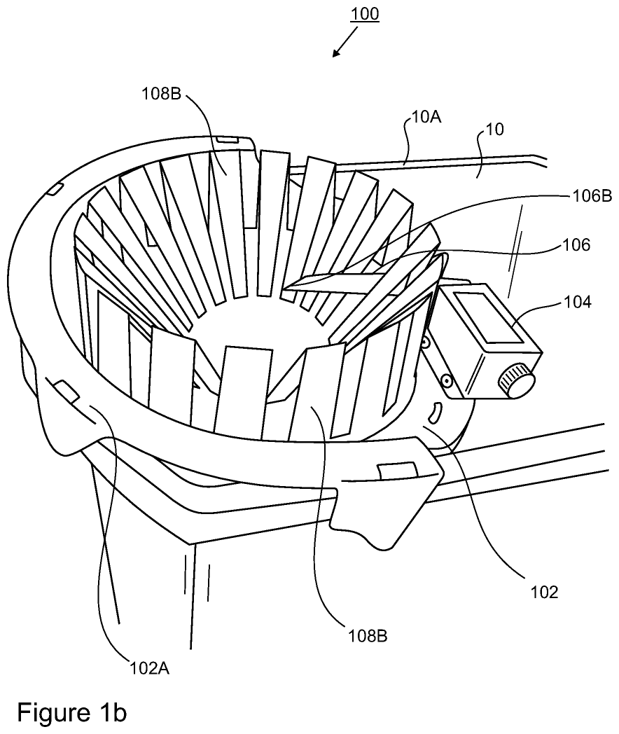

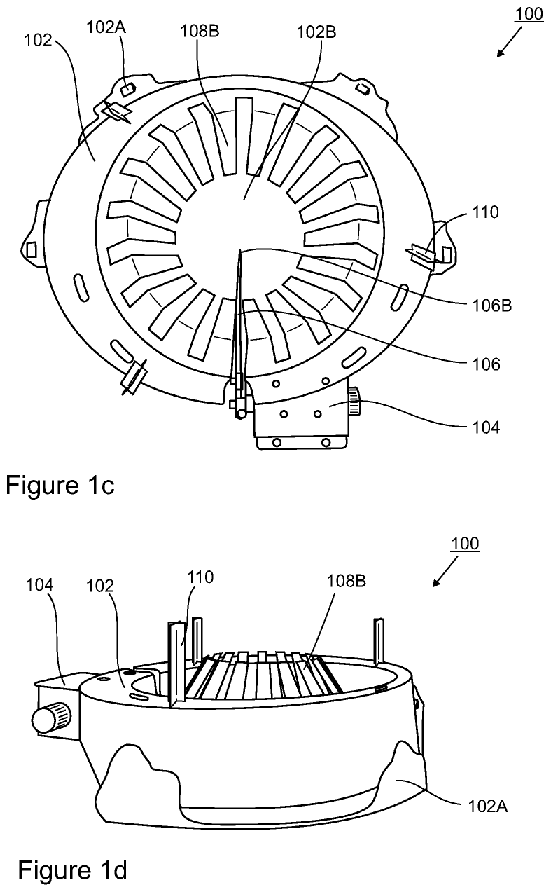

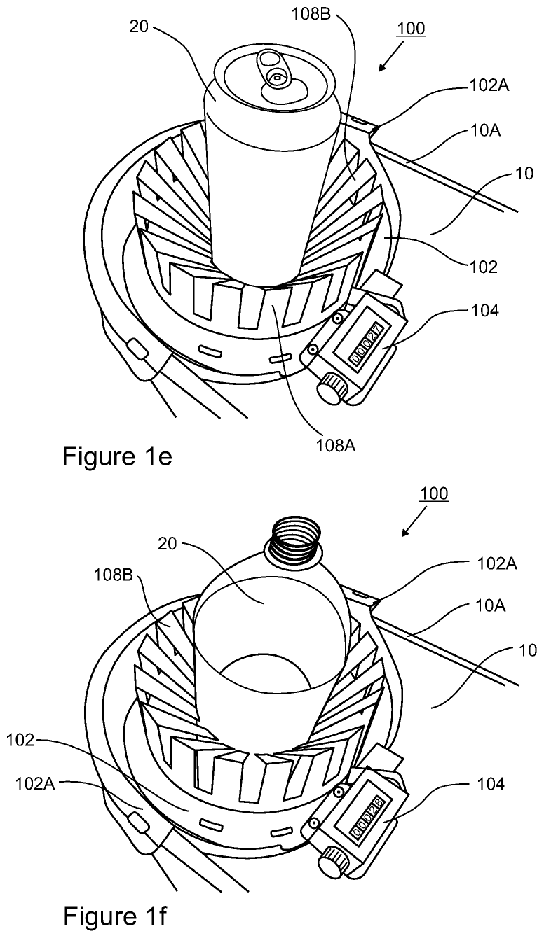

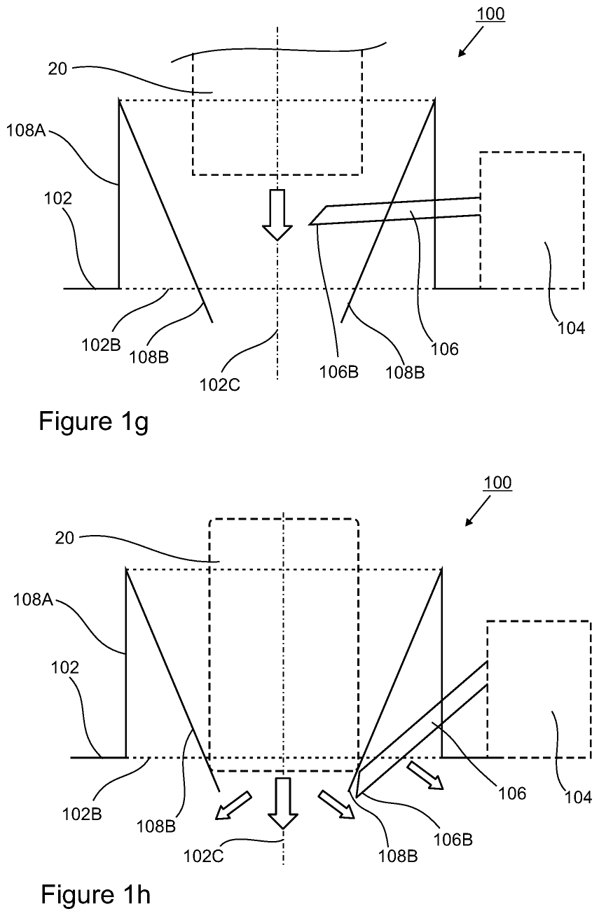

Referring to FIGS. 1a to 1h a counter for counting empty recyclable containers 100 according to a preferred embodiment of the invention is provided. The counter 100 comprises a holding structure 102 having an opening 102B disposed therein. The opening 102B is adapted for enabling placement of objects 20 therethrough into a collecting device 10 such as, for example, a recycle bin 10. Counting device 104 is mounted to the holding structure in proximity to the opening 102B such that the counting device 104 advances a count of the objects 20 by one when one of the objects 20 is moved through the opening 102B. Preferably, the counting device 104 is a mechanical counting device having a first end 106A of a lever 106 pivotally movable mounted to axle 104A thereof. The counting device 104 advances the count for each stroke of the lever 106, for example, a 45° degree stroke of the lever 106, which is shown on display 104B.

Typically, the lever 106 is returned to its original position using a spring. The count is easily reset via reset button 104C, for example, by pressing or turning the same after emptying the bin 10. Preferably, the mechanical counter is commercially available such as, for example, a GOGO Desktop Mechanical Tally Counter model KDCJ-AL0011.

The counter 100 is adapted for counting objects 20 having different size, for example, from small cans to large plastic bottles, as illustrated in FIGS. 1e and 1f. Preferably, in order to ensure that objects 20 of small or large size are counted, a guiding structure 108A, 108B is provided. The guiding structure 108A, 108B extends from the holding structure 102 such that the objects 20 when moved through the opening 102B are guided towards a second end 106B of the lever 106, which is placed, for example, in proximity to centre line 102C of the opening 102B, with the centre line 102C being oriented approximately perpendicular to a plane of the opening 102B.

Preferably, the guiding structure 108A, 108B comprises a plurality of flexible guiding elements extending from the holding structure 102 in proximity to the opening 102B. A first portion 108A of each of the guiding elements extends from the holding structure 102 having an orientation approximately opposite a direction of movement of the objects 20, indicated by a block arrow in FIGS. 1g and 1h, through the opening 102B. A second portion 108B of each of the guiding elements extends from the first portion 108A having an orientation in the direction of movement of the objects 20 and towards the second end 106B of the lever 106. In use, the objects 20 when moved through the opening 102B are guided towards the second end 106B of the lever 106 which is rotated around axle 104A when the objects 20 are in contact therewith, as indicated by the block arrow in FIG. 1h. When in contact with the second portion 108B of the guiding elements, further movement of the objects 20 pushes the same in a direction away from the centre line 102C, as indicated by the block arrows in FIG. 1h.

The counter 100 further comprises securing structure 102A adapted, for example, for securing the same to a top rim 10A of the bin 10 and, optionally, securing pins 110 for engaging the inside walls of the bin 10, as illustrated in FIGS. 1a to 1d. The counter 100 is easily placed on the top of a plastic bin 10 for counting the empty recyclable containers collected therein. Optionally, the empty recyclable containers are collected in a plastic bag placed inside the bin and secured thereto by clamping the same between top rim 10A of the plastic bin 10 and the securing structure 102A of the counter 100. When the plastic bag is filled, the counter 100 is removed from the plastic bag and the bin 10, enabling removal of the plastic bag from the bin 10. After removal the same is tied and the number of the count indicated on the display 104B is, for example, written onto the bag. After placement of a new bag inside the bin 10, the counter 100 is reset and placed again onto the rim 10A of the bin 10 such that the bag is clamped between the top rim 10A of the plastic bin 10 and the securing structure 102A of the counter 100.

The holding structure 102, the securing structure 102A, the guiding elements 108A, 108B, and the securing pins 110, are made of, for example, a plastic material such as Polyethylene (PE) using a conventional plastic moulding process. Furthermore, the holding structure 102, the securing structure 102A, and the guiding elements 108A, 108B may be made as a single unit. The counting device 104 is mounted to the holding structure 102 using conventional fasteners such as, for example, pop rivets, screw fasteners, or an adhesive. The lever 106 is made of, for example, sheet metal or sheet plastic material such as PE.

Alternatively, the first portion 108A of the guiding elements may be provided as a ring type structure extending from the holding structure and surrounding the opening 102B. An opening disposed in the ring type structure enables placement and movement of the lever 106 therethrough.

Further alternatively, the orientation in the direction of movement of the objects 20 of the second portion 108B may be omitted.

Further alternatively, if the opening 102B of the counter 100 is used for counting objects 20 having similar size, the guiding structure may be omitted.

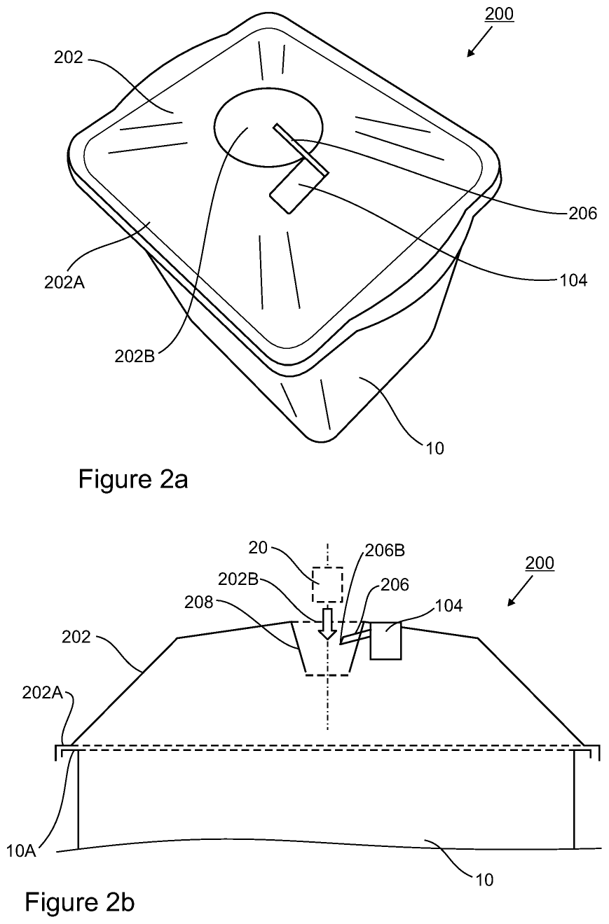

Referring to FIGS. 2a and 2b a counter for counting empty recyclable containers 200 according to another preferred embodiment of the invention is provided. The counter 200 comprises a holding structure 202 having an opening 202B disposed therein. The holding structure 202 is adapted to form a lid for being placed on top of bin 10 with rim structure 202A interacting with respective top rim structure 10A of the bin 10. For example, the holding structure 202 is raised from the rim structure 202A towards the location of the opening 202B. Guiding elements 208 extend from the holding structure 202 having an orientation in the direction of movement of the objects 20 and towards the second end 206B of the lever 206. It is noted that in order for the guiding elements to guide the objects towards the second end 206B of the lever 206, the placement of the counting device 104 or the shape of the lever 206 are adapted such that the second end 206B of the lever 206 is placed between the guiding elements 208. Alternatively, the holding structure 202 is substantially flat and the guiding structure is provided similar to the one illustrated in FIGS. 1a to 1h. As is evident to one skilled in the art, the counter 200 is easily adapted to fit various bin sizes and bin shapes.

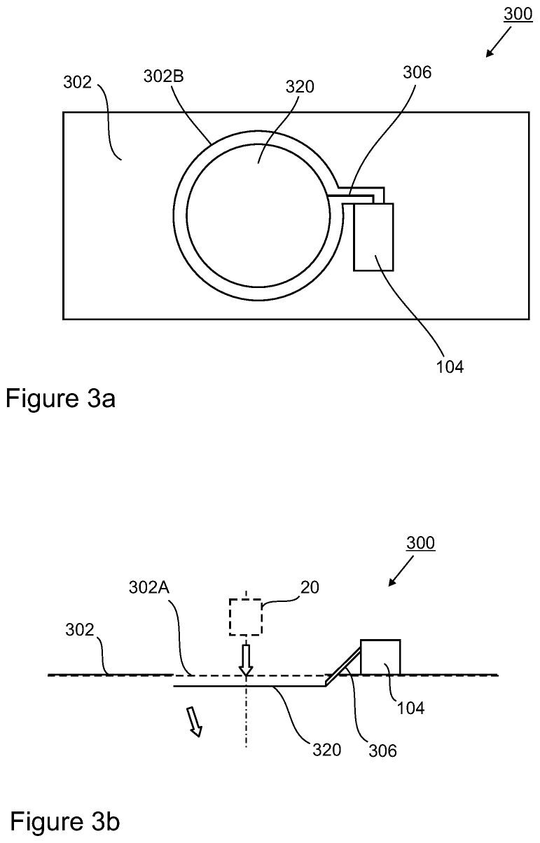

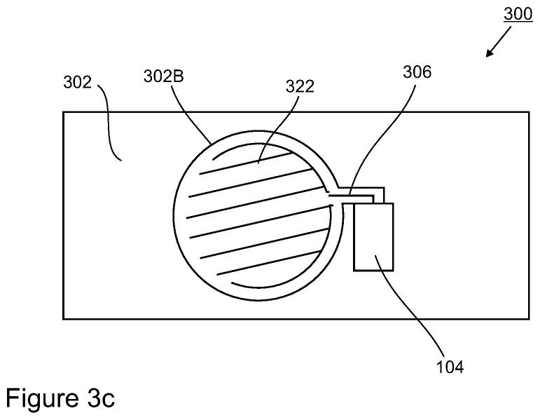

Referring to FIGS. 3a to 3c a counter for counting empty recyclable containers 300 according to yet another preferred embodiment of the invention is provided. The counter 300 comprises a holding structure 302 having an opening 302B disposed therein. In order to obviate the guiding structure, the counter 300 comprises an interacting structure 320, 322 connected to the lever 306, which is adapted for covering at least a substantial portion of the opening 302B to ensure that the lever 306 is rotated when smaller sized objects 20 are moved through the opening 302B, as indicated by the block arrows in FIG. 3b. The interacting structure may comprise a plate 320 or a fork 322, as illustrated in FIGS. 3a and 3c, respectively.

Optionally, the mechanical counting device 104 is replaced with a battery operated digital counting device capable of printing the count onto a label. Further optionally, the lever mechanism is replaced with a sensor such as, for example, an electro-optical sensor for detecting the presence of an object moved through the opening. Yet further optionally, the digital counting device is adapted for wirelessly communicating with, for example, a mobile device such as a smart phone, or tablet computer, to provide information related to the recyclable containers such as, for example, the number of containers presently collected.

The counters 100, 200, and 300 are simple and cost effective to manufacture for residential and small business use, for example, by providing a single unit made of plastic material in a conventional manner and attaching a commercially available mechanical counting device.

Furthermore, the counters 100, 200, and 300 are easy to install by, for example, placing them on top of a rim of a bin, and easy to use, for example, by simply pushing a button to reset the counting device.

Furthermore, the counters 100, 200, and 300 are easily adapted to fit various sizes and shapes of commercially available bins.

Furthermore, the counters 100, 200, and 300 are capable of counting containers having different sizes.

It is noted, that while the description of the preferred embodiments hereinabove is with reference to circular openings 102B, 202B, and 302B, it is evident to those skilled in the art that the embodiments of the invention are not limited thereto, but are also adaptable for employing different shaped openings such as, for example, rectangular or square shaped openings, depending on the shapes of the objects to be counted. Furthermore, while the description of the preferred embodiments hereinabove is with reference to a horizontal orientation of the plane of the openings 102B, 202B, and 302B, it is evident to those skilled in the art that the embodiments of the invention are not limited thereto, but are also adaptable for orienting the plane of the openings 102B, 202B, and 302B, vertically or at any angle therebetween.

The present invention has been described herein with regard to preferred embodiments. However, it will be obvious to persons skilled in the art that a number of variations and modifications can be made without departing from the scope of the invention as described herein.

What is claimed is:

1. A counter for counting objects placed therethrough into a collecting device comprising:
a holding structure having an opening disposed therein, the opening being adapted for enabling placement of the objects therethrough into the collecting device; and,
a counting device mounted to the holding structure in proximity to the opening such that the counting device advances a count of the objects by one when one of the objects is moved through the opening.

2. The counter according to claim 1 wherein the counting device is a mechanical counting device having a first end of a lever pivotally movable mounted thereto, and wherein the counting device is adapted for advancing the count for each stroke of the lever.

3. The counter according to claim 1 wherein the counter is adapted for counting objects having different size.

4. The counter according to claim 3 comprising a guiding structure extending from the holding structure into the opening such that the objects when moved through the opening are guided towards a second end of the lever.

5. The counter according to claim 4 wherein the guiding structure comprises a plurality of flexible guiding elements extending from the holding structure in proximity to the opening and having an orientation in the direction of movement of the objects and towards the second end of the lever.

6. The counter according to claim 5 wherein each of the guiding elements comprises a first portion extending from the holding structure in a direction opposite a direction of the movement of the objects through the opening and a second portion having an orientation in the direction of movement of the objects and towards the second end of the lever.

7. The counter according to claim 3 comprising an interacting structure connected to the lever, the interacting structure being adapted for covering at least a substantial portion of the opening.

8. The counter according to claim 7 wherein the interacting structure comprise one of a plate and a fork.

9. The counter according to claim 1 wherein the holding structure is adapted for being secured to a top rim of a bin.

10. The counter according to claim 9 wherein the holding structure is adapted to form a lid of the bin.
